(19) United States
(12) Patent Application Publication
(10) Pub. No.: US 2002/0029892 A1
(43) Pub. Date: Mar. 14, 2002

(54) Weeder Tool

(76) Inventor: Philip Clinton Jones, Squim, WA (US)

Correspondence Address: PHILIP CLINTON JONES, 555 EVANS RD., SQUIM, WA, 98382, US

(21) Appl. No.: 09/823,539

(22) Filed: Apr. 2, 2001

Related U.S. Application Data
(60) Provisional application No. 60/197,390, filed on Apr. 14, 2000.

(51) Int. Cl. A01B 1/00

(52) U.S. Cl. 172/371

(57) ABSTRACT

The weeder tool is V shaped angle iron having a pointed end and a welded cross bar 8 to 12 inches from the point attached to a pole or D-grip handle. It has no moving parts. It is used like a shovel operated by hand and body of the operator.

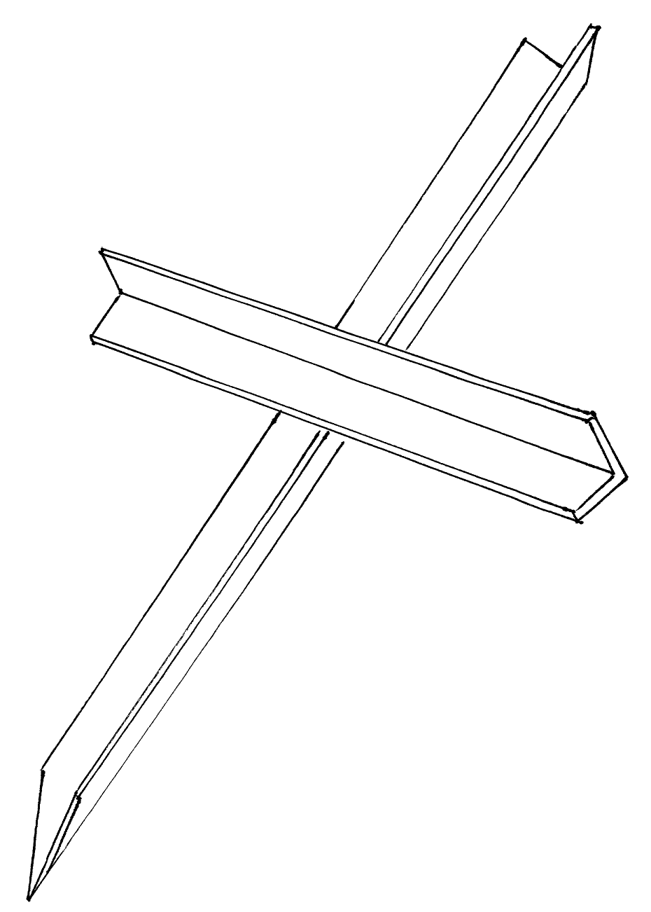

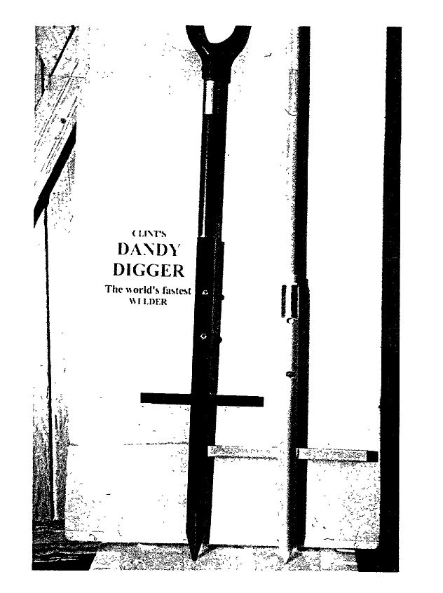

The point of the V is placed nearest the plant, 1-2 inches from the plant root center, and forced vertically into the ground by foot. The handle is then pushed back toward the ground causing the point to pivot on the crossbar opening the soil next to the weed exposing it and forcing the plant to rise out of the ground. The plant and roots rise with minimal ground disturbance. The broken divot can be tamped back by foot.

### BACKGROUND OF THE INVENTION

The present invention is an apparatus for removing unwanted plants from a specific area of the soil. The invention is comprised of a narrow pointed blade that is adapted to penetrate the surface of the soil and move substantially perpendicular to the soil surface and parallel to the weed root. The blade has a sharp point at one end and the other end is capable of receiving a handle. The handle end of the metal part is configured to receive a handle of various configurations, either a rake type handle consisting of a straight pole (fiberglass, wooden, or metal) or a short pole (fiberglass, wooden, or metal) with a “D” shaped grip handle similar to those associated with a spade.

Above the pointed end is a cross bar welded at right angles facilitating the forcing of the tool down with the weight of the foot. This combination allows the user to grip the handle to easily place the point of the tool where desired and with a quick stamp of the foot to drive the tool vertically into the ground. With the tool properly imbedded next to the weed root a quick back and downward pressure on the tool handle will cause the tool point to rise, pivoting on the foot bar, thus forcing the soil apart like an earthquake and pushing the root upward and outward. As the tool point rises it pushes the plant root upward and as the soil cracks open the plant occasionally will continue its upward velocity and jump clear of the soil surface.

### DESCRIPTION OF PRIOR ART

Weeds are an equal opportunity creature, they don't much care where and how they grow. Dandelions are a ubiquitous and annoying weed to many gardeners. Their long tap roots make them difficult to eradicate. However, digging the roots is the most effective way to remove them permanently. Chemicals often only stunt and delay the plants. Most weeding tools only cut off the tops of the plants, leaving the tap root intact for future growth.

Various forms of tool have been invented to assist in the removal of weeds. Most are designed to cut beneath the surface of the soil such as a hoe or so-called winged weeder type tool. Others are spades which dig up a clod of soil along with the plant necessitating the physical separation of the weed and the surrounding soil after the removal of the clod, leaving a large hole to be filled again. The effort required to work all the prior tools is often excessive, tiring and discouraging leading to an abandonment of the project.

### SUMMARY OF THE INVENTION

An effective weeding tool must be easy to use, powerful enough to penetrate the ground only minimally disturbing the surrounding soil and simple to operate. It must be able to remove not just the tip of the plant but the entire root to prevent regrowth. It must be sturdy and made to last. It must have few if any working parts which may break. It must be able to be used from a standing position as many people cannot easily bend down. It must also work fast to keep ones interest and satisfaction in the job. The present invention supplies all of the above as well as being useful in other gardening chores.

### BRIEF DESCRIPTION OF THE DRAWING

The tool blade is compose of one inch angle iron 18 to 24 inches long with a foot bar of ¾ inch angle iron welded at right angles between 8 to 12 inches from the pointed tip. That is to say the tool may have more than one configuration depending upon the depth of the tool desired. The depth of penetration is controlled by the distance of the point to the foot bar, presently offered as 8 inch and 12 inch lengths. The width of the foot bar may also vary, presently offered as 9 inches and 12 inches. There may also be attached a metal ring at the top end of the blade to facilitate the installation and receipt of the tool handle to give greater strength to the connection.

The configurations may vary with the length of the blade and the type of handle attached. The application for patent applies only to the form and shape of the tool head, not the handle.

### DETAILED DESCRIPTION OF THE INVENTION

The success of the weeder lies in the design, not the dimensions, of the ground-penetrating blade. The pointed blade tip gives perfect control of where the operator may wish to place the tool in relation to the targeted weed. The blade may be as narrow as one and one half (1½) inches to a little over two (2) inches wide. This gives minimal resistance to the ground as the weight of the operator, standing on the horizontal foot bar, forces the blade as deeply as may be desired, to the depth allowed by the foot bar. The impact of the tool on the ground extends several inches deeper than the tool itself allowing roots deeper than 12 or more inches to be freed.

The “V” shape of the tool head is critical to the success of the tool's operation. The “V” shape allows the broken soil to slide past each side of the blade as it rises from the ground with the point of the “V” facing upward. As the tip of the tool begins to rise beneath the weed root, the plant itself will begin to lift creating a domed effect on the plant and closely surrounding soil. If the plant does not rise, it has not been properly placed and should be repositioned to effect the initial rising. As the tool continues to rise, pushing the root ahead, the ground will crack open like an earthquake exposing the entire root. If the rate of rising is fast enough, the entire plant may break free and jump out of the ground. A quick stamp of the foot easily returns the divot.

The foot bar may be used to pry out more resistant weeds, once the ground has been broken, by turning the tool on its side and using it as a lever. Once the weed is on the ground, a quick swipe of the tool point will remove the weed from the immediate area, to either be raked up later or left to wither and die on the spot. The tool is so easily manipulated that even a one-armed person may successfully us it. This was proven by using one hand alone to operate the tool and the reports of such persons owning the tool.

1. A weeder capable of removing deeply rooted weeds rapidly and with a minimum of physical effort. A tool made of two pieces of common angle iron shaped like a cross with one end of the larger piece pointed and the opposite end attached to a handle convenient to the user. A shorter piece of angle iron is welded at right angle to the blade to serve as a foot bar to force the tool directly into the ground.
2. The simplicity of the shape and manufacture makes the tool attractive and economical to the user as well as durable and long lasting.
